(19) United States
(12) Patent Application Publication
(10) Pub. No.: US 2005/0159993 A1
(43) Pub. Date: Jul. 21, 2005

(54) System and method of presenting offers by way of a computer network

(76) Inventors: John Joseph Kordas, Orland Park, IL (US); Matthew Moog, Chicago, IL (US); Kenneth John Treske, Vernon Hills, IL (US)

Correspondence Address: WOODCOCK WASHBURN LLP, ONE LIBERTY PLACE, 46TH FLOOR, 1650 MARKET STREET, PHILADELPHIA, PA, 19103, US

(21) Appl. No.: 10/760,701

(22) Filed: Jan. 20, 2004

(51) Int. Cl. G06F 17/60

(52) U.S. Cl. 705/10

(57) ABSTRACT

A method and system for presenting an offer by way of a computer network is disclosed herein. In the method, consumer information and a plurality of offers are stored in a database, and a consumer session of a partner electronic interface is accessed by way of the computer network. The eligibility of the consumer to receive one of the plurality of offers is determined based on the stored consumer information. An offer is removed if the consumer is ineligible for the offer and the remaining plurality of orders are ordered and presented to the consumer by way of the partner electronic interface.

### FIELD OF THE INVENTION

The present invention relates to electronic commerce. More particularly, the present invention relates to a system and method of presenting offers by way of a computer network. Even more particularly, the present invention relates to a system and method for presenting offers to a user of a web site or other electronic interface, where the offers are either untailored or tailored based on user information stored in a central database.

### BACKGROUND OF THE INVENTION

For some time, advertisers have used the Internet as a medium to acquire or maintain customers. Conventionally, the most common method employed by advertisers to perform such a function is to present offers on a web site. The advertiser may present offers on its own web site, or the advertiser may pay a fee to a web site owner, and in return the advertiser is permitted to present an offer on the owner's web site. Conventionally, such advertisements are presented to every consumer who visits the site. Commonly, more than one advertiser wishes to present an offer on a particular web site. In such a situation, the web site may “rotate” the offers that are presented by each advertiser. For example, the web site may display the offers of the higher-bidding advertiser for a proportionately greater amount of time, or to a greater number of consumers, than the offers of a lower-bidding advertiser.

This method has several shortcomings. First, the advertisement is not tailored to the particular consumer who is viewing the site. Rather, the advertiser either displays the offer to all consumers (when only one advertiser is presenting offers), or to a consumer based simply on when it is the particular advertiser's “turn” to have its offer presented (when multiple advertisers are presenting offers). As a result, many consumers will see an offer that is unappealing. Nevertheless, and depending on the arrangement between the web site and advertiser, the advertiser may still have to pay the web site for the ability to display the offer—regardless of whether the consumers who view the offer are likely to be interested.

Another shortcoming is that a determination is not made as to whether a particular offer has already been presented to, or accepted by, a consumer. If an offer has already been presented to a consumer and the consumer decides not to select the offer, it is unlikely that the consumer will select the offer if it is presented again. Likewise, if the offer has already been redeemed by a consumer, the consumer should not receive another offer. Thus, valuable advertising opportunities are lost as offers are repeatedly presented to consumers who are not interested in them.

Conventionally, web sites are available that permit a consumer to supply demographic and/or psychographic information, which is then used by the web site to provide a consumer with targeted offers and discounts on goods and services. When a consumer first enters such a web site, the consumer must register by passing through several introductory web pages where certain required and optional information is requested. Privacy concerns are alleviated because a consumer's participation in the web site, as well as the consumer's entry of the information, is voluntary. Information requested by the web site may include the consumer's interests, salary range, location and other data. The information is entered into a database and used by the web site to select offers that are most likely to be of interest to the consumer from a pool of available offers, based on the supplied information. The site is thus customized for the consumer. For example, each time the consumer visits the web site, the consumer is presented with offers that are specifically targeted to the consumer. In addition, an entry in the database may indicate whether a consumer has previously been presented with an offer, thereby enabling the web site to present a different offer to the consumer.

Such a web site is beneficial for the consumer because the consumer sees offers of interest rather than general advertisements or offers that may not be applicable or desirable to the consumer. The web site is also beneficial to advertisers because an advertiser can reach a targeted audience of interested consumers, rather than having to display advertisements or offers to a larger audience of potentially disinterested consumers. Thus, offer redemption rates for the advertisers may be increased because of the targeting service provided by such a web site. An example of such a site is the web site provided by CoolSavings, Inc., which can be found at http://www.coolsavings.com.

However, even a customized web site has shortcomings. For example, an advertiser typically presents offers on multiple web sites. Therefore, a consumer may visit a first web site and be presented with an offer that is customized to the consumer. The consumer may decide not to select the offer, and then proceeds to a second web site. Even if the second web site is also customized for the consumer, it has no way of knowing that the particular offer was already presented at the first web site, and eventually it is likely that the second web site will present the offer again. As a result, another advertising opportunity is lost.

What is needed is a method of using a central server having a database of demographic and/or psychographic information to select and transmit offers to a consumer. More particularly, what is needed is a method of using a central server to present a web site or other type of electronic interface that is displayed as a partner interface, thereby enabling the central server to tailor offers to be presented to a consumer, or to simply send untargeted offers to a consumer. Even more particularly, what is needed is a method of tailoring offers to be presented to a consumer on a partner-branded web site by using information obtained by way of the partner-branded web site.

### SUMMARY OF THE INVENTION

In view of the foregoing limitations and drawbacks, a method and system for presenting an offer by way of a computer network is disclosed herein. In the method, consumer information and a plurality of offers are stored in a database, and a consumer session of a partner electronic interface is accessed by way of the computer network. The eligibility of the consumer to receive one of the plurality of offers is determined based on the stored consumer information. An offer is removed if the consumer is ineligible for the offer and the remaining plurality of orders are ordered and presented to the consumer by way of the partner electronic interface. In one embodiment, the method further determines whether the consumer is registered with the partner electronic interface and prompts the consumer for the consumer information if the consumer is not registered with the partner electronic interface. If the consumer is registered with the partner electronic interface, the method receives an identifier associating the consumer with the consumer information.

### BRIEF DESCRIPTION OF THE DRAWINGS

The foregoing summary, as well as the following detailed description of preferred embodiments, is better understood when read in conjunction with the appended drawings. For the purpose of illustrating the invention, there is shown in the drawings exemplary embodiments of the invention; however, the invention is not limited to the specific methods and instrumentalities disclosed. In the drawings:

FIG. 1A is a diagram illustrating an exemplary computer network in which aspects of the present invention may be implemented;

FIG. 1B illustrates an exemplary computer network and web page configuration according to one embodiment of the present invention;

FIG. 2 is a flowchart illustrating an exemplary method of procuring consumer information and storing said consumer information in a database;

FIG. 3 is an example of a web page configured to collect demographic and other information from a consumer;

FIGS. 4A and 4B are examples of web pages configured to collect psychographic and other information from a consumer; and

FIGS. 5A and 5B are flowcharts illustrating an exemplary method of presenting one or more offers to a consumer according to one embodiment of the present invention.

### DETAILED DESCRIPTION OF ILLUSTRATIVE EMBODIMENTS

Overview

The present invention relates to a system and method of providing targeted or untargeted offers to consumers. It will be appreciated that an “offer” may be any type of electronic marketing opportunity such as, for example, a web redirection, the presentation of an electronic form or coupon, a subscription offer, and the like. Accordingly, a consumer may “accept” an offer by any means appropriate to the form of the offer. For example, if the offer is a form, a consumer accepts the offer by filling out the form. In contrast, accepting a coupon may occur when a consumer selects the coupon for possible redemption, when the consumer actually redeems the coupon, or the like.

A central server has access to a database that contains information about one or more consumers. The information is received from the consumer during a registration or login process at a partner electronic interface, such as a web site or the like. “Electronic interface” refers to any means by which a consumer may interact with an offer and/or central server. A web site, each web page on a web site, Instant Messaging (IM) applications, Personal Digital Assistants (PDAs), cellular telephones, desktop applications, streaming data applications, and the like are all examples of an electronic interface, and all are equally compatible with an embodiment of the present invention. Although the description contained herein predominantly refers to web sites and web pages, it will be appreciated that an embodiment of the present invention is equally applicable to other forms of electronic interfaces.

The partner web site—or other type of electronic interface—is affiliated with a partner entity such as, for example, an e-commerce business. The central server is able to communicate with a partner server that hosts the partner web site and/or hosts a web page that is branded as the partner web site. The partner web site desires to present an offer or a coupon to a potential consumer, but does not want to present an offer that has already been presented to the consumer. Additionally, the partner web site may wish to present the offer only to potential consumers who may be predisposed or eligible to accept the offer. The offer may be presented on behalf of any entity, such as the partner web site or an unrelated third party.

Thus, in one embodiment a consumer visits the partner web site or other type of electronic interface and provides some type of information as requested by the web site as part of a registration process. If the consumer is already registered with the partner web site, the consumer may simply provide identifying information such as a password, email address, or may automatically be identified by way of a previously-set “cookie,” a unique identifier sent by the partner web site, or the like. The server that is hosting the partner web site—or partner-branded web site—transmits the information to the central server, which then uses the information to identify the consumer. In some embodiments, the server hosting the partner-branded web site may in fact be the central server, so therefore the above-referenced transmission of information may not be necessary. As will be discussed below, many computer and/or network configurations are consistent with an embodiment of the present invention. As noted above, an embodiment of the present invention may be implemented using web sites (e.g., hosted or presented by the central server), web services, IM applications, etc.

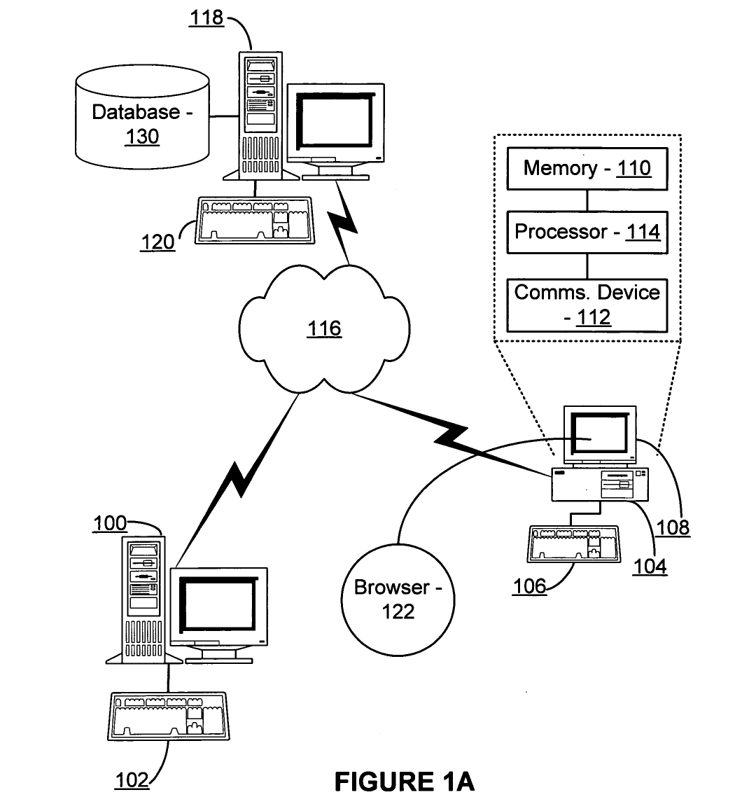

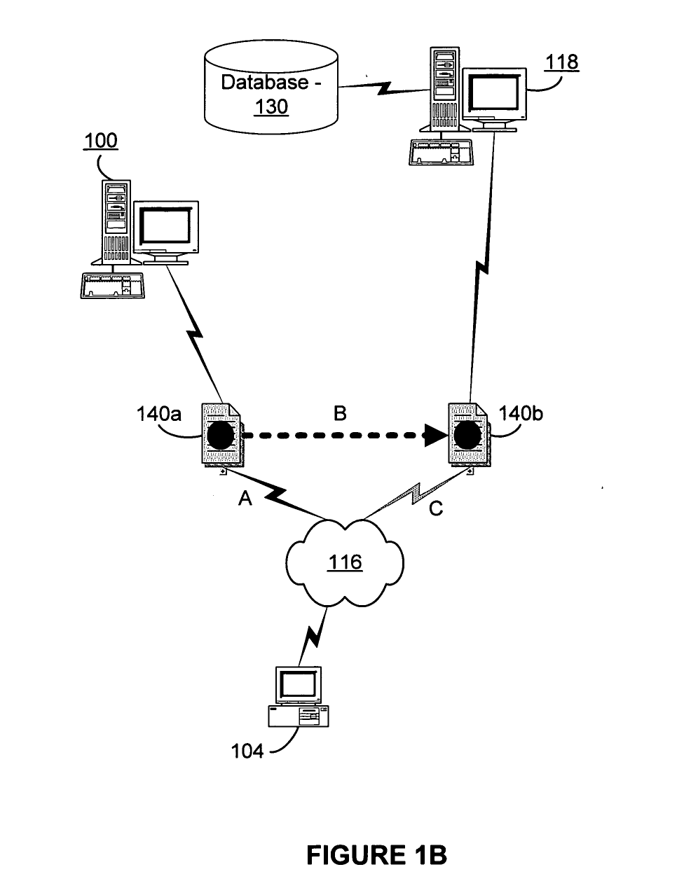

Thus, while the description to follow below in connection with FIG. 1B pertains to a html-based embodiment involving a hosted web site, other embodiments using, for example, web services, IM applications, and the like are possible. In one embodiment, the central server takes a predetermined set of offers and determines, based on consumer information stored in the database, whether the consumer is eligible to receive the offers. If the consumer is not eligible for an offer, the offer is removed and not presented to the consumer. The central server processes the offers in the database to determine an order in which to present the offers to consumers. In doing such processing, the server may account for any number of factors, such as a commission value of the offer, the number of a particular offer available to be presented to consumers, and the like. The server may also incorporate randomizing functions or other functions into the process to vary the order of offer presentation.

In the presently-discussed embodiment, the central server presents the offer to the consumer by way of the partner web site and indicates a result of the presentation such as, for example, the fact that the offer was presented and whether the consumer accepted the offer. Such results are recorded in the database for use in determining whether future offers will be made to the consumer or other consumers.

Several partner web sites may be connected to—or hosted by—the central server by way of their partner servers (or directly by way of the central server) for the purpose of determining whether to present offers to consumers. Each partner web site may be independent from the other web sites, and in fact may be competing with them. In one embodiment, whenever an offer is presented by on behalf of any of the partner web sites, result data are recorded in the database. Thus, as long as the consumer can be identified by the central server a partner web site will not make the same offer to the same consumer twice—even if the offer was first presented by another partner web site. The tracking of offers presented and the responses to such offers enables the database to provide statistical correlations between the types of offers that are likely to be accepted by different groups of consumers based on a wide array of criteria. This information can then be used to further refine targeting.

### Exemplary Embodiments

FIG. 1A is a diagram illustrating an exemplary computer network in which aspects of the present invention may be implemented. Partner server 100 provides functionality necessary to generate a web site to be displayed on a local or remote computer. As will be appreciated in the discussion that follows, the partner server 100 may be owned and operated by the owner of the web site, or may be owned by a third party that is contracted, or the like, to host the web site. In such a case where the partner server 100 is owned by a third party, it may be more accurately referred to as a “presentation” web server 100, although the exact nomenclature of the web server 100 is irrelevant with respect to an embodiment of the present invention.

In one embodiment, partner server 100 may be any general purpose or specialized computing device capable of generating the web site. In embodiments using types of electronic interfaces other than web pages (e.g., the above-mentioned desktop applications, IM interfaces, etc.), the partner server 100 is capable of presenting the electronic interface in a format appropriate to the interface. Partner server 100 may be controlled by input device 102. Input device 102 may be any device or devices that can be used to interact with partner server 100 such as, for example, a keyboard, mouse, stylus, touch screen, microphone, network connection from another computing device, cellular network or the like. Partner server 100 is operatively connected to network 116, which may be any type of computer network such as, for example, a Local Area Network (LAN), a Wide Area Network (WAN), the Internet, a wireless network, and so forth. The connection between the partner server 100 and the network 116 may be made by way of a telephone modem, cable modem, ISDN, fiber optics, wireless network or the like.

Central server 118, like partner server 100, is operatively connected to the network 116 and may be any computing device capable of communicating with the partner server 100 and interacting with the database 130. In addition, the central server 118 may be capable of presenting one or more web pages that are “branded” as a partner web page. “Branding” refers to the practice of presenting a web page that appears to be presented by the partner entity, but in fact is presented by a different entity. It will be appreciated that embodiments of the present invention may be carried out by using other networking configurations. For example, the central server 118, rather than presenting a branded web page, may enable the presentation of such web page by another server. In one embodiment, the central server 118 may transmit information to and receive information from another server such as, for example, partner server 100 by using web services. In such an embodiment, eXtensible Markup Language (XML) data may be transmitted back and forth between the central server 118 and the partner server 100. As may be appreciated, in such an embodiment the central server 118 may control all or part of the content of the web page—by supplying such content to the presentation web server—without actually generating the web page itself. As noted above, any type of network or communications configuration, as well as any type of electronic interface, may be used in connection with an embodiment of the present invention such as, for example, IM, streaming data, and the like. In addition, desktop and other types of applications having the ability to send and receive data—in addition to, or in place of a browser 122—may be employed to accomplish such an electronics interface.

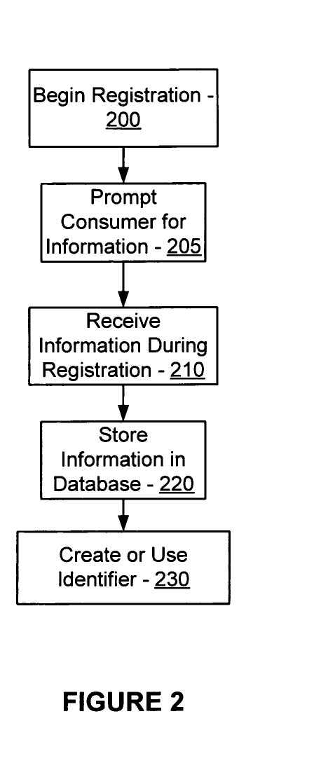

As may be appreciated, the central server 118 may itself contain the database 130, or may be operatively connected to the database 130 by way of a communications connection, another computing device or a network (not shown in FIG. 1A for clarity). The database 130 contains demographic and/or psychographic information, for example, about at least one consumer. Such information may be obtained by way of a registration process on a web site or the like as will be discussed below in connection with FIGS. 2-4B. In addition, the database 130 may be implemented using any suitable database software, whether conventional or specialized. The central server 118 also comprises input device 120 that may be a device as disclosed above in connection with input device 102. While in one embodiment of the present invention the central server 118 and partner server 100 are separate servers, in other embodiments servers 118 and 100 are the same server. In such embodiments, the database 130 can be operatively connected to the single server that provides the functionality of both web servers 118 and 100. In yet another embodiment, the central server 118 may be operatively connected to one or more additional servers (not shown in FIG. 1A for clarity) that may perform one or more tasks on behalf of the central server 118.

Computer 104 is also operatively connected to network 116. Computer 104 comprises input device 106 that, like input device 120, may be a device as disclosed above in connection with input device 102. Computer 104 also comprises processor 114 for data processing, memory 110 for storing data, communications device 112 for communicating with the network 116 and/or display device 108 for displaying information to a consumer. On display device 108 browser 122 displays an electronic interface such as a web page or the like to the consumer. The consumer may interact with, for example, a web page by using input device 106 to click on a hyperlink present in the web page as displayed by browser 122 on display device 108. Computer 104 may be either a desktop computer or the like, or may be a device such as a cellular telephone, personal digital assistant (PDA) and the like. Browser 122 may be any software program designed to allow the viewing of, and interaction with, an electronic interface, such as a web page or the like.

Other configurations of web servers 100 and 118, network 116 and computer 104 are possible and well known in the art, and all are equally consistent with the present invention. Furthermore, in the following description, methods and systems of programming and implementing electronic interfaces such as web sites and the like are assumed to be known to one skilled in the art and are therefore not described in detail herein. It will be appreciated that the discussion that follows is predominantly focused on embodiments pertaining to the presentation of offers on a web site. The discussion is limited to such embodiments solely for the sake of clarity, as any type of electronic interface, and means for presenting such an electronic interface, is equally consistent with an embodiment of the present invention.

Turning now to FIG. 1B, an exemplary computer network and web page configuration according to one embodiment of the present invention is presented. As can be seen in FIG. 1B, computer 104, partner server 100, central server 118, database 130 and network 116 are illustrated, and are configured as discussed above in connection with FIG. 1A. In one embodiment, computer 104 operatively connects to web page 140a by way of the network 116 and communications link A. It will be appreciated that communications link A may be any type of communications link that enables computer 104 to interact with content available on the web page 140a. As can be seen, web page 140a is provided by partner server 100. As noted above in connection with FIG. 1A, the web page 140a may be provided by any server capable of presenting a web page. As was also noted above in connection with FIG. 1A, other networks and/or communications protocols may be used to implement an embodiment of the present invention such as, for example, web services, IM applications, streaming data, other desktop applications, etc. Thus, it will be appreciated that web page 140a is merely one example of a partner electronic interface, in addition to the incomplete listing of examples, above.

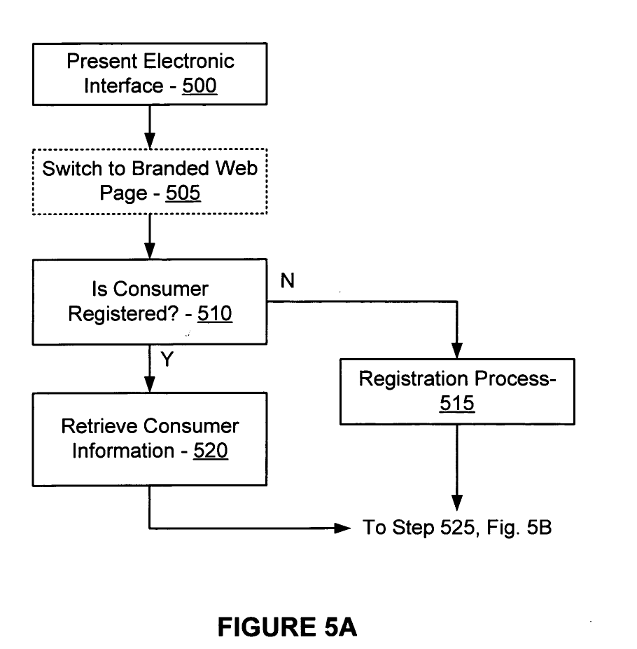

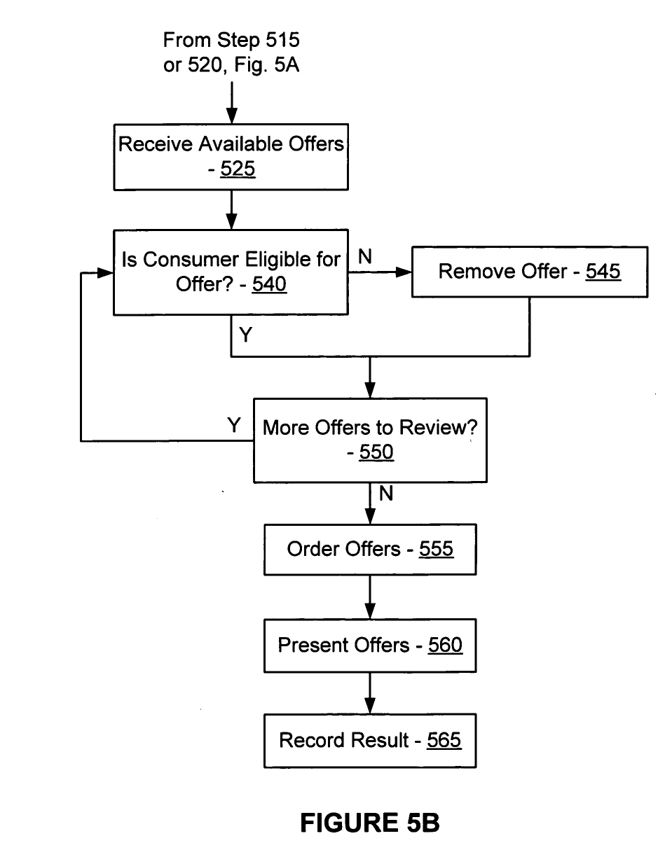

In one embodiment of the present invention, and as will be discussed in greater detail below in connection with FIG. 5A, at some point during computer 104's interaction with web site 140a, the computer is shifted to web page 140b as represented by arrow B. As a result, computer 104 is connected to web page 140b by way of the network 116 and communications link C. Such a shift may be triggered, for example, by the user clicking on a hyperlink displayed in web page 140a, by entering information in a field presented on web page 140a, automatically upon detection of a cookie or other identifier, and so forth. Alternatively, partner server 100 also generates web page 140b while receiving input—by way of a web service or the like—from central server 118. As can be seen in FIG. 1B, the offer data on web site 140b originates from a central server 118. In such a manner, central server 118 may present data from database 130 directly to a consumer by way of web page 140b. As mentioned above in connection with the discussion of “branding,” web page 140b may retain visual styling such that it is indistinguishable that web page 140b is being presented by a different server, and/or by a different entity, than that which presented web page 140a. In embodiments where the data is supplied by the central server 118 but presented by the partner server 100, the web page 140b may appear the same because it is still being presented by the same web server.

As will be discussed below in connection with FIGS. 5A and 5B, a method according to one embodiment of the present invention uses the configuration of FIGS. 1A and 1B to present an offer to a consumer. In such a method, the offer may be untargeted, that is, available to all consumers, regardless of their consumer data. Alternatively, and importantly, the offer may be targeted based on the consumer demographic and/or psychographic information stored in the database 130. The collection of such demographic and/or psychographic information is therefore first discussed below in connection with FIGS. 2-4B.

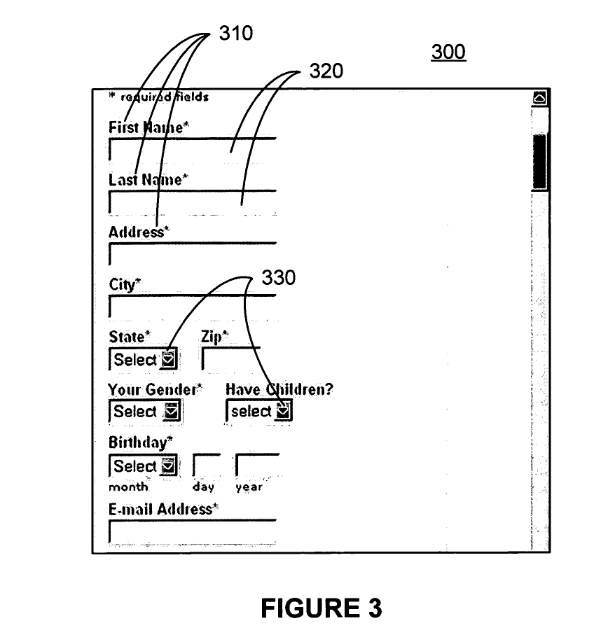

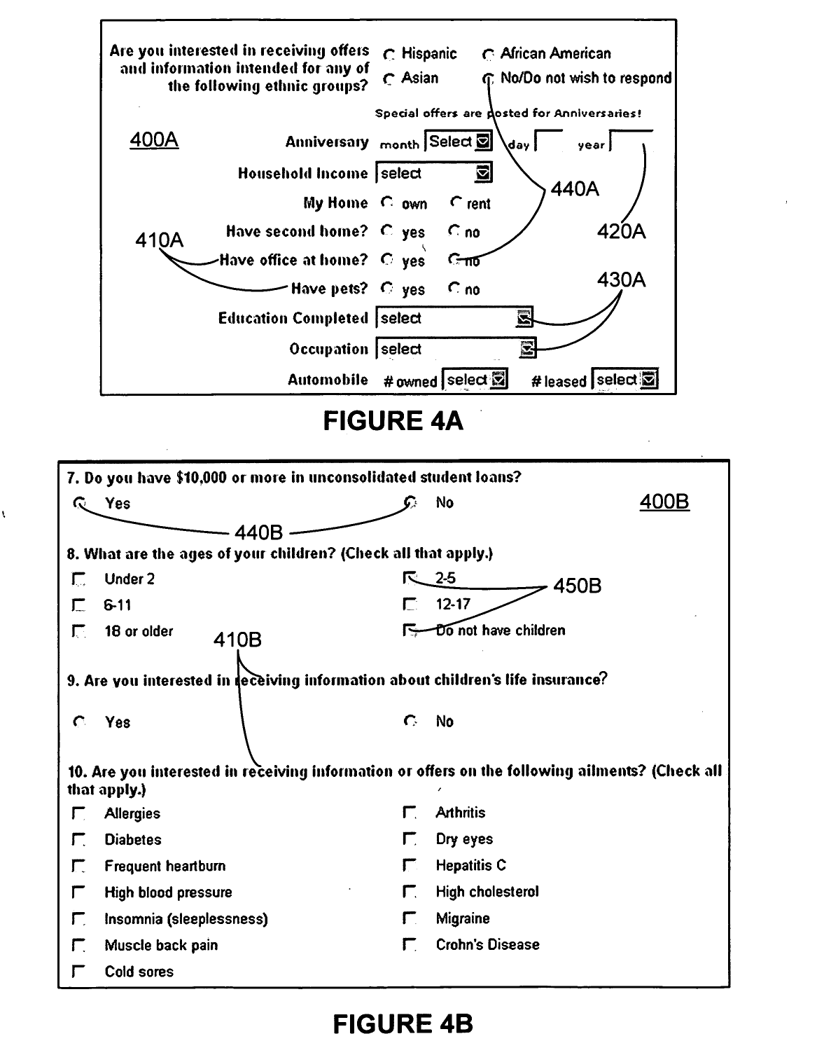

Turning now to FIG. 2, a flowchart illustrating an exemplary method of procuring consumer information and storing said consumer information in a database is provided. At step 200, a registration process begins. Step 200 may occur upon a consumer entering a registration web page by, for example, entering the registration web page's address or by “clicking” on a hyperlink. As will be discussed below in connection with FIGS. 5A and 5B, in one embodiment the registration process may be prompted to begin by an event at a first web page such as, for example, web page 140a of FIG. 1B. Then, the registration process may be carried out at a second web page such as, for example, web page 140b. At step 205, the consumer is prompted to enter consumer information. An example of various tools that may be employed to effectuate such prompting is discussed below in connection with FIGS. 3, 4A and 4B.

At step 210, information is received such as, for example, by way of web site 300 of FIG. 3 or the like. Such information may be received as part of a registration or sign-on process as noted above, or the information may be collected offline. In an embodiment of the present invention where the information is received by a web site, demographic information such as that shown below in Table 1 may be collected.

TABLE 1

| First Name | Last Name | | |
|---|---|---|---|
| Address | City | State | ZIP |

| Email Address | Periodic Email Offers Desired? | |
|---|---|---|
| Gender | Birthday | Have Children? |

| | |
|---|---|
| Create Password | Save password |

Are you interested in receiving offers and information intended
for any of the following groups?

| | | | |
|---|---|---|---|
| Anniversary | Household income | Own/Rent Home | Have second home |

| | | |
|---|---|---|
| Have office at home | Education completed | Occupation |

| | |
|---|---|
| Have pets? | What pets do you own? |

Automobile -# owned; # leased
Old E-mail Address
Interests
How many people are there in your household?
What is your marital status?
Are you a member of a warehouse club where you shop regularly?
Who lives in your household? - You (female/male) Year of
birth; Adult 2 (Female/male) Year of birth; Adult 3
(female/male) Year of birth
Do you have children under 18 living in your household?
What year was your youngest child born?

As may be appreciated, the information of Table 1 is merely exemplary, as any type or amount of information may be requested of and received from the consumer. Table 2, as shown below, includes exemplary questions and possible answers to determine a psychographic makeup of the consumer. The questions are designed to elicit responses that indicate the preferences of the consumer. As was the case with Table 1 above, Table 2 is merely exemplary, as any type or form of questions and/or possible answers may be used in an embodiment of the present invention.

TABLE 2
Are you looking to use the equity in your home to make
home improvements, pay off debts, or
to make a major purchase?

| | |
|---|---|
| Yes | No |

Do you need a cash advance on your next paycheck?

| | |
|---|---|
| Yes | No |

Are you single and interested in joining an online dating service?

| | |
|---|---|
| Yes | No |

Are you interested in lowering your healthcare expenses 20-80%
with an inexpensive alternative to medical and dental insurance?

| | |
|---|---|
| Yes | No |

Are you planning to get married in the next 18 months?

| | |
|---|---|
| Yes | No |

Do you have $10,000 or more in unconsolidated student loans?

| | |
|---|---|
| Yes | No |

What are the ages of your children?

| | | | | | |
|---|---|---|---|---|---|
| Under 2 | 2-5 | 6-11 | 12-17 | 18 or older | Do not have children |

Are you interested in receiving information or offers
on the following ailments?

| | | | | |
|---|---|---|---|---|
| Allergies | Arthritis | Diabetes | Dry eyes | Frequent heartburn |

| | | | |
|---|---|---|---|
| Hepatitis C | High blood pressure | High cholesterol | Migraine |

| | | | |
|---|---|---|---|
| Insomnia | Crohn's Disease | Muscle back pain | Cold sores |
| (sleeplessness) | | | |

Have you made an online or mail order purchase in the last 12 months? If so, which?

| | | | |
|---|---|---|---|
| Online | Mail Order (catalog) | Both | Neither |

Are you planning to do any of the following in the next 3 months?

| Move to a new home | Major home renovation project | | Expect a baby |
|---|---|---|---|
| Retire | Travel | Cruise | Plan a wedding |

Do you own any of the following?

| | | | | |
|---|---|---|---|---|
| DVD player | Home computer | Color printer | Video recorder | Video game console |

| | |
|---|---|
| Cable TV | High-speed Internet access |

Do you intend to buy any of the following in the next 3 months?

| | | |
|---|---|---|
| Home computer | Printer | Camera/Digital camera |
| DVD player | Digital satellite service | Cell phone/Accessories |
| Video game console | High-speed Internet access | Leather Jackets and Accessories |
| Computer components | Video games | Bed/Mattress |
| New Car | Jewelry | |

Which of the following would you like to get more information about?

| | | |
|---|---|---|
| Health club memberships | Home fitness equipment | Diet/weight control |
| Vitamins/health supplements | Medical products and services | Collectibles/memorabilia |
| Antiques | Gourmet cooking/fine foods | Wine |
| Auction Web sites | | |

Which of the following describes you or your spouse?

| | | |
|---|---|---|
| Work in a small business | Own small business | Full-time home maker |
| College/university student | Federal Employee | Retired None of the above |

Are you interested in receiving smoking-related offers?

| | |
|---|---|
| Yes | No |

Once the receipt of information in step 210 is complete, the method proceeds to step 220. At step 220, the information received above in connection with step 210 is stored in a database such as, for example, database 130. As was discussed above in connection with FIG. 1A, database 130 may comprise any type of data storage software that is implemented in any type of computer hardware that is operatively connected to central server 118. However, it should be noted that in one embodiment of the present invention, the entry of the information into database 130 is performed by a different computer than central server 118. As may be appreciated, if the receipt of data discussed above in connection with step 210 was conducted offline, data entry—either automated or manual—takes place before the information is stored in database 130. For example, a third party may have acquired such data and then transferred it (electronically or otherwise) to the central server 118 for storage.

At step 230, an identifier is created or extracted from the information submitted by the consumer and stored. In one embodiment of the present invention, the identifier is assigned to the consumer information using any type of numbering and/or naming convention. In another embodiment, the identifier is a field of data, or the like, that is extracted from the information received from the consumer as in step 210 above and used to identify the information stored in database 130. The identifier is stored in database 130 and, in some embodiments, is also stored on a consumer computer 104. When the identifier is stored in computer 104, such identifier can be stored as part of a cookie or the like.

FIG. 3 is an example of a web page configured to collect demographic and other information from a consumer. Web page 300 comprises prompts 310 that indicate to a consumer the type of information web page 300 desires the consumer to input. As may be appreciated, in one embodiment such information is then stored in database 130 (not shown in FIG. 3 for clarity). Any type of information may be requested by prompt 310 including, but not limited to, the information disclosed above in connection with Table 1. Blank 320 is a space on web page 300 that permits the consumer to enter text such as, for example, the consumer's first name. Pull-down menu 330 is another tool that may be used to enable the consumer to enter information. As should be known by those of skill in the art, a pull down menu, when selected, has a list of answer options that the consumer may scroll through to find and select the most appropriate answer. As can be seen in FIG. 3, some fields are denoted as “mandatory,” while others are implicitly optional. In one embodiment, a mandatory field must be filled out by the consumer for the completed web page 300 to be accepted. It will be appreciated that any number of fields, or none at all, may be designated as mandatory. The data collected from web page 300 may be stored to the database upon completion of the page (e.g., upon selecting “Submit” or the like), may be stored as the information is entered, or in any other manner.

FIGS. 4A and 4B are examples of web pages configured to collect psychographic and other information from a consumer. Referring first to FIG. 4A, web page 400A, like web page 300, comprises prompts 410A designed to elicit desired information from a consumer. Web page 400A employs several tools to enable such a consumer to input the information. Blank 420A permits a user to enter text information or the like. Pull-down menu 430A, which may operate in the same or a similar manner to pull-down menu 330, is also present on web page 400A. Radio buttons 440A typically operate in a toggle, on-off fashion whereby the consumer may select radio button 440A to indicate an answer to prompt 410A.

Turning now to FIG. 4B, web page 400B is shown to further demonstrate the types of web pages that may be employed to gather consumer psychographic and other information. As was the case with web pages 300 and 400A, discussed above, web page 400B comprises prompts 410B designed to elicit desired information from the consumer. In an embodiment, radio buttons 440B and check boxes 450B are also present to receive consumer responses.

As may be appreciated from the questions present in FIGS. 3, 4A and 4B, as well as the information contained in Tables 1 and 2, any type of information may be requested of the consumer as part of the registration process as discussed above in connection with FIG. 2. The information requested may be general consumer information intended for a variety of purposes, specific information intended for a specialized purpose, or the like. As may also be appreciated, the collection of demographic and psychographic information may be performed on a single web page, rather than on a plurality of web pages 300, 400A and 400B. In addition, such information may be collected using any of the tools discussed in connection with FIGS. 3, 4A and 4B, and may also involve any other tools that may be implemented by way of a web page. A consumer may also enter data offline, where the information is ultimately entered into a database 130. As noted above in connection with FIG. 3, the information may be received from a third party as well.

Turning now to FIGS. 5A and 5B, flowcharts illustrating an exemplary method of presenting one or more offers to a consumer according to one embodiment of the present invention are shown. It will be appreciated in the discussion of FIGS. 5A and 5B that in one embodiment an agreement, or the like, governs the exact operation of the method disclosed herein. For example, a partner web site may desire that consumer information collected on its web site not be used to tailor offers to consumers when the consumer is browsing another entity's web site. A partner web site may also desire that consumer information collected by other web sites not be used when tailoring offers to consumers visiting its own web site. Furthermore, in one embodiment, the consumer information collected by other web sites that is stored in the database 130 is not accessible to the partner web site. Rather, only the consumer information collected by the partner web site may be accessible to the partner web site. In another embodiment, a privacy policy, agreement or the like may be used to govern whether a partner web site may access consumer information gathered from another web site, and to what extent. It will be appreciated that any such configuration is equally consistent with an embodiment of the present invention. It will also be appreciated that configurations having such limitations on information accessibility may affect the accuracy of any offer tailoring performed by the central server 118. In addition, a consumer may be presented with the same offer more than once, because the partner web site in such a configuration might not know if the offer has already been presented to the consumer.

Turning now to FIG. 5A, and at step 500, a partner electronic interface such as, for example, web page 140a as discussed above in connection with FIG. 1B, is presented to a consumer. At some point while the consumer is browsing the web page, a offer presentation operation is undertaken. For example, in one embodiment, a consumer clicks on an area of the web page that corresponds to offer presentation. In another embodiment, the presentation of offers occurs automatically according to some predetermined criterion or criteria.

In one embodiment, and at optional step 505, the consumer is shown a partner-branded web page such as, for example, web page 140b, which is hosted by, for example, web server 118 or a web server in operative communications with web server 118. In one embodiment, the showing of a partner-branded web page occurs upon the consumer clicking on a hyperlink served by the central server 118, thereby transferring control of the consumer session to the central server 118. In yet another embodiment, the original web server may retain control of the consumer session, and may communicate with the central server 118 to transmit information to and receive offers from the central server 118. For example, the consumer may remain on a third-party web site, while the third-party web site queries—by way of web services or the like—the central server 118 for information to display. In either embodiment, the central server 118 gains access to the consumer session on the partner electronic interface.

At step 510, a determination is made as to whether the consumer is already registered with the particular partner. Such a determination may be made by, for example, reading a cookie, receiving login information from the consumer, receiving an identifier from a partner website and/or the like. If the determination of step 510 is that the consumer is not already registered, then the method performs a registration process at step 515. Such a registration process may take place as discussed above in connection with FIGS. 2-4B, and typically involves the collection of demographic and/or psychographic information about the consumer. If, in contrast, the determination of step 510 is that the consumer is registered, and therefore demographic and/or psychographic information is on record, then the method proceeds to step 520, at which time the consumer registration information is retrieved from a database such as, for example, the database 130 discussed above in connection with FIGS. 1A-B. After either step 515 or 520, the method proceeds to step 525 of FIG. 5B.

Turning now to FIG. 5B, at step 525, valid offers that are available for presentation to consumers are retrieved from the database 130. An offer may be determined to be invalid if, for example, the offer has expired, has already been accepted by consumers a maximum number of times, and so forth. At step 540, a determination is made as to whether the consumer is eligible to receive an offer. For example, if the particular offer has already been accepted by the consumer, then in one embodiment the consumer is no longer eligible to receive the offer. In another embodiment, the consumer may or may not remain eligible for an offer if the offer has already been presented but not accepted. Other criteria may also render a consumer ineligible to receive an offer. For example, an offer may only be intended for a consumer with children, a certain income level, marital status, gender, and/or the like. As may be appreciated, any type and/or combination of criteria for making an eligibility determination is equally consistent with an embodiment of the present invention. In addition, any of the demographic and/or psychographic information that is stored in the database 130 may be used to make such a determination. If the consumer is determined to be ineligible for the offer at step 540, the method proceeds to step 545.

At step 545, the offer for which the consumer is ineligible is removed from the consumer's pool of available offers and the method proceeds to step 550. At step 550, a determination is made as to whether any more offers are to be reviewed and, if so, the method returns to step 540 to determine whether the consumer is eligible for such offers. As may be appreciated, steps 540-550 may be repeated as many times as necessary to determine whether the consumer is eligible for any of the offers to be presented. Once the determination of step 540 is that no more offers are to be reviewed, the method either proceeds to optional step 555 (if step 555 is to be taken) or to step 560.

At step 555, the offers to be presented are ordered. It will be appreciated that the ordering of the offers to be presented may take place for any number of reasons. For example, the offers may be ordered based on the consumer's demographic and/or psychographic information, thereby enabling closer tailoring of the offers to the consumer's preferences. Any criteria may be used to order the offers. For example, an entity that has an offer to be presented may offer an entity associated with the central server 118 a fee when its offer is presented and/or accepted by a consumer. Thus, the central server 118 may place an offer with a high fee towards the top of the order. Likewise, offers that are more likely to be accepted may also be placed towards the top of the order. It will be appreciated that additional considerations may be taken into account when ordering the offers. For example, some offers with high fees may have a low redemption rate, and some offers with low fees may have a high redemption rate. As a result, the ordering of step 530 may order the offers to maximize profits by ranking the offers in a manner that will likely generate the greatest amount of fees. Furthermore, such ordering may be conducted, for example, in an automated, real-time fashion. In one embodiment, the ordering may be conducted by the central server 118 on-demand, as necessitated by consumers visiting a partner electronic interface. Alternatively, such ordering may be performed according to a schedule. It will be appreciated that any number and/or combination of factors may be considered when ordering the offers, and that ordering of the offers may be accomplished in any manner. Any such number and/or combination of factors and/or manner for ordering is equally consistent with an embodiment of the present invention.

At step 560, the offers are presented in the order determined in step 555, above. At step 565, a result of the offer presentation is recorded in the database 130. A result to be recorded can be, for example, whether the consumer selected the offer, whether the consumer accepted a selected offer, and the like. Additional information may also be recorded. For example, if an offer is for any of a line of products, such additional recorded information may include the exact product or products redeemed by the consumer. Furthermore, it will be appreciated that impression tracking and other types of reporting, marketing or other tools may be employed at step 565, and any of such tools are equally consistent with an embodiment of the present invention. In short, any type or combination of information may be recorded with respect to the presented offer, and any such type or configuration of information is consistent with an embodiment of the present invention.

Thus, a method and system for presenting offers to a user of an electronic interface, where the offers are either untailored or tailored based on user information stored in a central database has been provided. While the present invention has been described in connection with the exemplary embodiments of the various figures, it is to be understood that other similar embodiments may be used or modifications and additions may be made to the described embodiment for performing the same function of the present invention without deviating therefrom. For example, one skilled in the art will recognize that the present invention as described in the present application may apply to emails and other non web page applications. Therefore, the present invention should not be limited to any single embodiment, but rather should be construed in breadth and scope in accordance with the appended claims.

1. A method of presenting an offer by way of a computer network, comprising:
storing consumer information and a plurality of offers in a database;
accessing a consumer session of a partner electronic interface by way of the computer network;
determining the eligibility of the consumer to receive one of the plurality of offers based on the stored consumer information;
removing an offer if the consumer is ineligible for the offer; and
presenting the remaining plurality of offers to the consumer by way of the partner electronic interface.

2. The method of claim 1, further comprising ordering the remaining plurality of offers.

3. The method of claim 1, further comprising:
determining whether the consumer is registered with the partner electronic interface;
prompting the consumer for the consumer information if the consumer is not registered with the partner electronic interface; and
receiving an identifier associating the consumer with the consumer information if the consumer is registered with the partner electronic interface.

4. The method of claim 3, wherein the identifier is a cookie.

5. The method of claim 3, wherein the determination is made by receiving login information from the consumer.

6. The method of claim 1, wherein accessing the consumer session comprises assuming control of the consumer session of the partner electronic interface from a partner server.

7. The method of claim 6, wherein the partner electronic interface is a partner web page, and assuming control comprises hosting a partner-branded web page.

8. The method of claim 1, wherein accessing the consumer session comprises communicating with a partner server to enable the partner server to present the partner electronic interface.

9. The method of claim 8, wherein said communication is by way of a web service.

10. The method of claim 1, wherein accessing the consumer session comprises detecting a consumer action on the partner electronic interface, and presenting a second electronic interface to the consumer responsive to the consumer action.

11. The method of claim 10, wherein the consumer action is clicking on a hyperlink.

12. The method of claim 1, wherein the partner electronic interface is a web site.

13. The method of claim 1, wherein ordering the remaining plurality of offers is based on a fee to be paid for presenting the remaining plurality of offers.

14. The method of claim 1, wherein ordering the plurality of offers is based on a fee to be paid for a consumer accepting one of the presented offers.

15. The method of claim 1, wherein the consumer information is demographic information.

16. The method of claim 1, wherein the consumer information is psychographic information.

17. The method of claim 1, further comprising updating the consumer information to reflect the presentation of the remaining plurality of offers to the consumer.

18. The method of claim 1, further comprising updating the consumer information to reflect a consumer action with respect to one of the remaining plurality of offers.

19. The method of claim 18, wherein the consumer action is a redemption of the offer.

20. A method of presenting an offer by way of a computer network, comprising:
storing consumer information and a plurality of offers in a database;
accessing a consumer session on a partner web page by way of the computer network;
determining whether the consumer is registered with the partner;
prompting the consumer for the consumer information if the consumer is not registered with the partner and storing the consumer information in the database;
receiving an identifier associating the consumer with the consumer information if the consumer is registered with the partner;
determining the eligibility of the consumer to receive one of the plurality of offers based on the stored consumer information;
removing an offer if the consumer is ineligible for the offer and ordering the remaining plurality of orders; and
presenting the remaining plurality of offers to the consumer by way of the partner web page.

21. The method of claim 20, wherein the identifier is a cookie stored on a consumer computing device.

22. The method of claim 20, further comprising assigning the identifier to the consumer if the consumer is not registered with the partner web site.

23. The method of claim 20, wherein accessing the consumer session comprises hosting a partner-branded web page.

24. The method of claim 20, wherein accessing the consumer session comprises communicating with a partner web server to present the partner web page.

25. The method of claim 20, wherein accessing the consumer session is a result of the consumer clicking on a hyperlink on the partner web page.

26. The method of claim 20, wherein ordering the remaining plurality of offers is based on a fee associated with each of the remaining plurality of offers.

27. The method of claim 20, wherein ordering the plurality of offers is based on an anticipated consumer response to the presented offers.

28. The method of claim 20, further comprising updating the consumer information to reflect the presentation of the remaining plurality of offers to the consumer.

29. The method of claim 20, further comprising updating the consumer information to reflect a consumer action with respect to one of the remaining plurality of offers.

30. A system for presenting an offer by way of a communications network, comprising:
means for storing consumer information and a plurality of offers in a database;
means for accessing a consumer session of a partner electronic interface by way of the communications network;
means for determining the eligibility of the consumer to receive one of the plurality of offers based on the stored consumer information;
means for removing an offer if the consumer is ineligible for the offer and ordering the remaining plurality of orders; and
means for presenting the remaining plurality of offers to the consumer by way of the partner electronic interface.

31. The method of claim 30, further comprising:
means for determining whether the consumer is registered with the partner electronic interface;
means for prompting the consumer for the consumer information if the consumer is not registered with the partner electronic interface; and
means for receiving an identifier associating the consumer with the consumer information if the consumer is registered with the partner electronic interface.

32. A system for presenting an offer by way of a computer network, comprising:
a database, wherein the database stores consumer information and a plurality of offers;
a web server operatively connected to a communications network and the database, wherein the web server accesses a consumer session of a partner web page by way of the computer network, determines the eligibility of the consumer to receive one of the plurality of offers based on the stored consumer information, removes an offer if the consumer is ineligible for the offer, orders the remaining plurality of orders, and presents the remaining plurality of offers to the consumer by way of the partner web page.

33. The system of claim 32, wherein the web server determines whether the consumer is registered with the partner electronic interface, prompts the consumer for the consumer information if the consumer is not registered with the partner electronic interface, and receives an identifier associating the consumer with the consumer information if the consumer is registered with the partner electronic interface.

34. A computer-readable medium having computer-readable instructions for performing a method of presenting an offer by way of a computer network, the method comprising:
storing consumer information and a plurality of offers in a database;
accessing a consumer session of a partner electronic interface by way of the computer network;
determining the eligibility of the consumer to receive one of the plurality of offers based on the stored consumer information;
removing an offer if the consumer is ineligible for the offer and ordering the remaining plurality of orders; and
presenting the remaining plurality of offers to the consumer by way of the partner electronic interface.

35. The computer-readable medium of claim 34, wherein the method further comprises:
determining whether the consumer is registered with the partner electronic interface;
prompting the consumer for the consumer information if the consumer is not registered with the partner electronic interface; and
receiving an identifier associating the consumer with the consumer information if the consumer is registered with the partner electronic interface.

36. A computer-readable medium having computer-readable instructions for performing a method of presenting an offer by way of a computer network, the method comprising:
storing consumer information and a plurality of offers in a database;
accessing a consumer session on a partner web page by way of the computer network;
determining whether the consumer is registered with the partner;
prompting the consumer for the consumer information if the consumer is not registered with the partner and storing the consumer information in the database;
receiving an identifier associating the consumer with the consumer information if the consumer is registered with the partner;
determining the eligibility of the consumer to receive one of the plurality of offers based on the stored consumer information;
removing an offer if the consumer is ineligible for the offer and ordering the remaining plurality of orders; and
presenting the remaining plurality of offers to the consumer by way of the partner web page.
